(19) United States
(12) Patent Application Publication
(10) Pub. No.: US 2022/0080943 A1
(43) Pub. Date: Mar. 17, 2022

(54) Fleet Management of Electric Vehicles Based on Battery Profiles and Conditions

(71) Applicant: TWS Technology (Guangzhou) Limited, Guangzhou (CN)

(72) Inventor: Charles Liu, Belmont, CA (US)

(21) Appl. No.: 17/352,715

(22) Filed: Jun. 21, 2021

Related U.S. Application Data
(60) Provisional application No. 63/078,477, filed on Sep. 15, 2020.

(51) Int. Cl. B60W 10/26; B60L 58/14; G08G 1/00; B60W 40/04; B60W 40/105; H04W 4/40

(52) U.S. Cl. CPC B60W 10/26; B60L 58/14; G08G 1/20; B60W 40/04; B60W 2555/60; H04W 4/40; B60W 2556/45; B60W 2510/246; B60W 2510/244; B60W 40/105

(57) ABSTRACT

Embodiments include methods for a wireless device configured for use with a vehicle powered by a battery. Such methods include receiving first status information associated with the battery via a first short-range wireless connection and determining location information associated with the vehicle. Such methods include transmitting the location information and the first status information to a management server via the wide-area wireless network. Other embodiments include complementary methods for a management server to manage one or more vehicles powered by batteries. Such methods include determining first control information for the battery based on the location information and the first status information and transmitting the first control information to the wireless device via the wide-area wireless network. Other embodiments include wireless devices and management servers configured to perform such methods.

### RELATED APPLICATIONS

The present invention claims priority to U.S. Prov. Appl. 63/078,477 filed Sep. 15, 2020, the entirety of which is incorporated herein by reference for all purposes.

### TECHNICAL FIELD

The present invention generally relates to electric vehicles (EVs), and more specifically relates to techniques for managing shared EVs (e.g., a fleet of such EVs) based on capabilities and/or conditions of each EV's battery.

### BACKGROUND

An electric vehicle (EV) uses one or more electric motors to drive the EV's wheels for propulsion. In most cases, EVs are powered by battery packs carried on the EV, with the size of the battery pack being related to the size, weight, and performance requirements of the EV itself. In some instances, the EV may also include an internal combustion engine that runs on fossil fuel(s); these are often referred to as hybrid EVs. Many different types of EVs are currently being produced or planned for production, including cars, trucks, buses, motorcycles, scooters, and trains. In addition to these EVs that operate on hard surfaces (e.g., roads), other current or planned EVs include aircraft, surface ships, underwater vessels, and spacecraft.

The battery packs used in most EVs contain a large collection of rechargeable cells and are controlled by battery management systems (BMS). A battery pack with built-in BMS may also be referred to as a “smart battery pack” or “intelligent battery pack.” Among other tasks, a BMS protects the battery pack from operating outside its safe operating area, 'monitors its state, calculates and reports battery status information, and receives control information from a host platform (e.g., vehicle). Communications with a host vehicle can be facilitated by an external communication interface, which can also be used to communicate with other host platforms such as battery chargers and diagnostic stations. The communication interface may be included in the same or a different wiring harness or connector as the wires that carry energy between the battery and the host platform.

Recently, shared transportation has grown rapidly due to a renewed interest in urbanism and growing environmental, energy, and economic concerns that have intensified the need for sustainable alternatives. This has been facilitated by advances in electronic and wireless technologies, which have made sharing vehicles easier and more efficient. These services can be divided into two main types: ride sharing (or shared ride), where users are matched to empty seats in a vehicle; and vehicle sharing (or shared vehicle), where a single vehicle is available for use by any subscriber to the service. EVs are increasingly being used in shared-vehicle services, including scooter-sharing services such as such as Lime, Bird, etc.

These shared-vehicle services typically involve a fleet of many vehicles (e.g., scooters) distributed over a geographic area in some manner. For a given geographic area, both the number of vehicles required to provide the service and their distribution over the area can vary based on a complex variety of factors including number of service users, distribution of users vs. geography and time, user movement of vehicles, desired level of service availability (e.g., vehicle unavailability), vehicle maintenance, etc.

Management of shared vehicles over a geographic area is a complex task but conventionally is based primarily on knowledge of current locations of such vehicles. However, management based on vehicle location information may be insufficient to meet end-user expectations and/or a service provider's cost requirements and/or logistics limitations.

### SUMMARY

Embodiments of the present disclosure provide specific improvements to management of battery-powered vehicles (e.g., for shared-vehicle services), such as by facilitating solutions to overcome exemplary problems summarized above and described in more detail below.

Some embodiments include methods (e.g., procedures) for a wireless device (e.g., user equipment, modem, etc.) configured for use with a vehicle powered by a battery. These exemplary methods can include receiving first status information associated with the battery via a first short-range wireless connection. These exemplary methods can also include determining location information associated with the vehicle. These exemplary methods can also include transmitting the location information and the first status information to a management server via the wide-area wireless network.

In some embodiments, the first status information includes one or more of the following: current state of charge (SOC), current state of health (SOH), over temperature (OT) indicator, and one or more error code (EC) counters.

In some embodiments, these exemplary methods can also include receiving first control information for the battery from the management server via the wide-area wireless network and transmitting the first control information via the first short-range wireless connection. In some embodiments, the first control information can be based on the location information and the first status information.

In some embodiments, the first control information includes one or more of the following: a command to limit a discharge rate of the battery; a command to stop discharge of the battery; and a service notification for the battery.

In some of these embodiments, the command to limit the discharge rate can be based on one or more of the following: a maximum allowed speed at a current vehicle location, an indication of high vehicle and/or pedestrian traffic at the current vehicle location, and a current SOC of the battery.

In some of these embodiments, the command to stop discharge of the battery can be based on one or more of the following: danger or hazard associated with the current vehicle location, an indication that the vehicle has been stolen, a current SOH of the battery, an OT indicator, and one or more EC counters exceeding respective thresholds.

In some embodiments, these exemplary methods can also include transmitting second status information associated with the vehicle to the management server via the wide-area wireless network and receiving second control information for the vehicle from the management server via the wide-area wireless network.

In some of these embodiments, the second status information can include one or more of the following: total usage for the vehicle, usage since the most recent service to the vehicle, total cycles of the battery, vehicle error codes, and vehicle accelerometer records. In some of these embodiments, the second control information can include a service notification and/or an alarm notification.

In some of these embodiments, these exemplary method can also include receiving the second status information via the first short-range wireless connection or via a second short-range wireless connection with the vehicle; and transmitting the second control information via the first short-range wireless connection or via the second short-range wireless connection.

In some of these embodiments, the first short-range wireless connection can be between the wireless device and a battery management system (BMS) arranged to control the battery. In such embodiments, wireless device can receive the second status information and transmit the second control information via the second short-range wireless connection.

In other of these embodiments, the first short-range wireless connection can be between the wireless device and the vehicle. In such embodiments, wireless device can receive the second status information and transmit the second control information via the first short-range wireless connection.

In some embodiments, the determined location information can include one or more of the following: current location, one or more past locations, current speed, one or more past speeds, current heading, current route, and starting point and destination for a current route. In some of these embodiments (e.g., when the location information includes a current route), these exemplary methods can also include receiving, from the management server, information associated with one or more locations along the current route. In some of these embodiments, the information associated with the one or more locations include identifiers of businesses located at the one or more locations and/or information about services offered at the one or more locations.

Other embodiments include methods (e.g., procedures) for managing one or more vehicles powered by batteries. These exemplary methods can be performed by a management server (e.g., for fleet management) and can include receiving, from one of the wireless devices, location information for an associated vehicle and first status information for the associated vehicle's battery. These exemplary methods can also include determining first control information for the battery based on the location information and the first status information. These exemplary methods can also include transmitting the first control information to the wireless device via the wide-area wireless network.

In some embodiments, the first status information includes one or more of the following: current SOC, current SOH, OT indicator, and one or more EC counters. In some embodiments, the location information can include one or more of the following: current location, one or more past locations, current speed, one or more past speeds, current heading, current route, and starting point and destination for the current route.

In some embodiments, determining the first control information can include determining a maximum discharge rate of the battery based on a maximum allowed speed at a current vehicle location, an indication of high vehicle and/or pedestrian traffic at the current vehicle location, and/or a current SOC of the battery. In such embodiments, the first control information can include a command to limit a discharge rate of the battery according to the determined maximum discharge rate.

In other embodiments, determining the first control information can include detecting one or more of the following:
a danger or hazard associated with the current vehicle location,
an indication that the vehicle has been stolen,
the current SOH of the battery is below a minimum operational threshold,
one or more EC counters have exceeded respective thresholds, and
an OT indication.
   In such embodiments, the first control information can include a command to stop discharge of the battery. In other embodiments, determining the first control information can include determining a service notification for the battery based on a current SOH of the battery.

In some embodiments, these exemplary methods can also include receiving, from the wireless device, second status information for the associated vehicle; determining second control information for the vehicle based on the location information and the second status information; and transmitting the second control information to the wireless device via the wide-area wireless network. In some of these embodiments, the first control information can also be determined based on the second status information and/or the second control information can also be determined based on the first status information.

In some of these embodiments, the second status information includes one or more of the following: total usage for the vehicle, usage since the most recent service to the vehicle, total cycles of the battery, vehicle error codes, and vehicle accelerometer records. In some of these embodiments, the second control information can include a service notification and/or an alarm notification.

In some embodiments, the one or more vehicles comprises a fleet of vehicles. In such embodiments, these exemplary methods can also include receiving, from wireless devices associated with the respective fleet vehicles, respective location information for the vehicles and respective first status information for the vehicle batteries; and determining a preferred geographic distribution of the vehicles of the fleet based on the respective location information and the respective first status information.

In some of these embodiments, determining the preferred geographic distribution can include determining that a first number of vehicles are in a first geographic area based on the location information; determining a SOC statistic for the vehicles in the first geographic area based on the first status information; and determining that the first number should be increased when the SOC statistic is below a first threshold. In some cases, determining the preferred geographic distribution can also include determining that the first number should be decreased when the SOC statistic is above a second threshold. In various embodiments, the SOC statistic can be mean, median, minimum, or maximum.

In some embodiments, the location information can include a current route and these exemplary methods can also include determining one or more locations along the current route and sending, to the wireless device, identifiers of businesses located at the one or more locations and/or information about services offered at the one or more locations.

Other embodiments include wireless devices and management servers configured to perform operations corresponding to any of the exemplary methods described herein. Other embodiments include non-transitory, computer-readable media storing program instructions that, when executed by processing circuitry, configure such wireless devices and management servers to perform operations corresponding to any of the exemplary methods described herein.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 shows an exemplary integration of a battery pack into a host platform (e.g., EV) according to conventional techniques.

FIG. 2A shows an exemplary integration of the battery pack shown in FIG. 1 with a charging station host platform.

FIG. 2B shows an exemplary integration of the battery pack shown in FIG. 1 with a diagnostic station host platform.

FIG. 3 shows an exemplary set of discharge curves for a lithium ion (Li-Ion) cell with 4.2V nominal voltage and nominal capacity of approximately 2.1 Amp-hour (Ah).

FIG. 4 shows an exemplary communication arrangement between a wireless device, an EV host platform, and a management server, according to various exemplary embodiments of the present disclosure.

FIG. 5 shows an exemplary re-distribution of EVs among different locations within a service area using a management server, according to various embodiments of the present disclosure.

FIG. 6 shows a flow diagram of an exemplary method for a wireless device (e.g., user equipment), according to various embodiments of the present disclosure.

FIG. 7, which includes FIGS. 7A-7B, shows a flow diagram of an exemplary method for a management server, according to various embodiments of the present disclosure.

FIG. 8 shows a block diagram of an exemplary wireless device or user equipment (UE), according to various embodiments of the present disclosure.

FIG. 9 shows a block diagram of an exemplary network node.

FIG. 10 is a schematic block diagram illustrating a virtualization environment suitable for a management server, according to various embodiments of the present disclosure

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. Any feature of any of the embodiments disclosed herein can be applied to any other embodiment, wherever appropriate. Likewise, any advantage of any of the embodiments can apply to any other embodiments, and vice versa. Other objects, features, and advantages of the disclosed embodiments will be apparent from the following description.

Furthermore, the following terms are used throughout the description given below:
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (JAB) node, a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), an access and mobility management function (AMF), a session management function (AMF), a user plane function (UPF), a Service Capability Exposure Function (SCEF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with “user equipment” (or “UE” for short). Some examples of a wireless device include, but are not limited to, smart phones, mobile phones, cell phones, voice over IP (VoIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, navigation devices, wireless customer-premise equipment (CPE), mobile-type communication (MTC) devices, Internet-of-Things (IoT) devices, vehicle-mounted wireless terminal devices, device-to-device (D2D) UEs, etc.
Network Node: As used herein, a “network node” is any node that is either part of the radio access network (e.g., a radio access node or equivalent name discussed above) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.

Note that the following description is in the context of a 3GPP cellular communications system and, as such, 3GPP terminology (or equivalent) is often used. However, the concepts disclosed herein are not limited to a 3GPP system. Furthermore, although the term “cell” may be used herein, it should be understood that (particularly with respect to 5G/NR) beams may be used instead of or in addition to cells and various concepts described herein apply equally to both cells and beams.

As briefly mentioned above, management shared vehicles (e.g., scooters) over a geographic area (e.g., a city) is a complex task but conventionally is based primarily on knowledge of current locations of such vehicles. However, management based on vehicle location information may be insufficient to meet end-user expectations and/or a service provider's cost requirements and/or logistics limitations. This is discussed in more detail below.

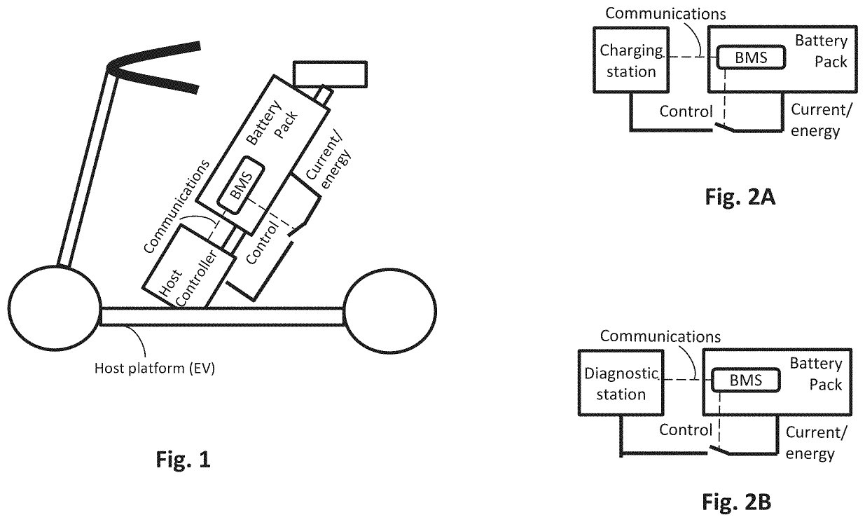

FIG. 1 shows an exemplary electric vehicle (EV). Although the EV is illustrated in FIG. 1 as a scooter, this is only used to exemplify any type of EV, such as others described herein. As shown in FIG. 1, the EV includes a host controller that connects to a battery pack, which can include a battery management system (BMS). The host controller can include one or more processors, memories, communication interfaces, etc. can be integrated into the EV, e.g., as an electronics module. The host controller and BMS can communicate via a wired communications interface, such as any type of wired communications bus known to skilled persons to be suitable for this application.

As briefly mentioned above, a BMS protects the battery pack from operating outside its safe operating area, 'monitors its state, calculates and reports battery status information, and receives control information from a host platform (e.g., vehicle). The BMS can also control the flow of current and/or energy from the battery pack to the host platform. In general, the BMS can control this flow based on conditions internal to the battery pack and/or commands from the host controller via the communications interface. The current/energy flow and the communications interface can be on the same or different connectors on the battery pack.

EVs are increasingly being used in shared-vehicle services, including scooter-sharing services such as such as Lime, Bird, etc. These services often include a large number of identical EVs with battery packs that are removable to facilitate charging, maintenance, and replacement. FIG. 2A shows an exemplary integration of the battery pack shown in FIG. 1 with a charging station host platform. In contrast to FIG. 1, the energy/current flow is from the charging station to the battery pack. The charging station can also communicate with the BMS via the communication interface. The charging station can be located in various places that may or may not be under the control of the battery pack manufacturer or the shared-vehicle service provider.

FIG. 2B shows an exemplary integration of the battery pack shown in FIG. 1 with a diagnostics station host platform. The diagnostic station can also communicate with the BMS via the communication interface. The diagnostics station shown in FIG. 2B can be in the battery pack factory, in a manufacturer service depot, in a field service depot, etc., each of which may have different diagnostic and/or service capabilities. Depending on the particular arrangement, the energy/current flow in FIG. 2B may be in one or both directions, or may not occur (e.g., battery pack and diagnostic station are self-powered).

Each battery pack includes some number of rechargeable energy cells that can receive electric current from a host platform, store it as charge, and then deliver the stored charge as electric current to a host platform (e.g., EV). Each energy cell is rated at a nominal voltage, which is fixed by the electrochemical characteristics of the active chemicals used in the cell (e.g., “cell chemistry”). For example, Lithium Ion (Li-Ion) cells have a nominal voltage of 4.2V. However, the actual voltage appearing at the cell terminals at any particular time depends on the load current to the host platform as well as the cell's internal impedance, operating temperature, state of charge (SOC), and age.

Likewise, each cell is rated at a nominal discharge rate current (C), but typically can operate at discharge rates above and below the nominal (e.g., up to 5C). Each cell also has a total charge capacity, which it typically given as a product of current and time, e.g., amp-hours (Ah). In general, the SOC of a battery pack can indicate either the portion of the total capacity that remains, or the portion of the total capacity that has been exhausted. Even so, the effective capacity of a cell can vary based on the discharge rate. In other words, the effective capacity of the cell can decrease if it is discharged at very high rates (e.g., 5C), or can increase if it is discharged at very low rates (e.g., 0.2C). This effect is often referred to as “capacity offset.”

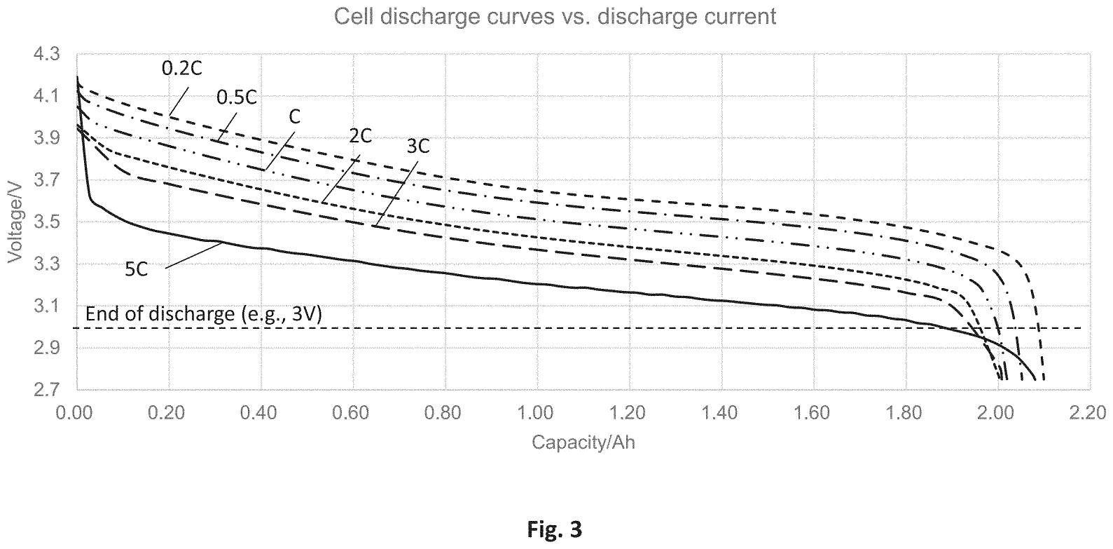

FIG. 3 shows an exemplary set of discharge curves for a Li-Ion cell with 4.2V nominal voltage and nominal capacity of approximately 2.1 Ah. The exemplary discharge curves—which collectively can be referred to as a “discharge profile”—show a range of cell behavior for discharge currents ranging from 0.2C to 5C. For lower discharge currents (e.g., 0.2C), the actual voltage provided by the cell during discharge remains relatively high until nearly the entire capacity has been discharged, at which point the output voltage falls off rapidly. As the discharge rate increases, the actual voltage shifts downward for a given amount of discharge. For example, there is approximately 0.3V difference between 0.2C and 3C rates over much of the discharge range, and approximately 0.5V difference between 0.2C and 5C rates over the same range.

The instantaneous power delivered by discharging a cell is the product of the instantaneous discharge current and actual voltage. The discharge energy delivered by discharging a cell is the sum of instantaneous power during time of discharge. In the context of the graph in FIG. 3, the discharge energy for a given discharge current (e.g., 0.2C) is the area under the discharge curve associated with that discharge current. As such, even though instantaneous power generally increases with increasing discharge current, total discharge energy generally decreases with increasing discharge current due to the capacity offset discussed above.

In general, the SOC of a battery pack comprising a collection of cells is the sum of the SOC of the individual cells. In addition to SOC, another status indicator for a battery pack is state of health (SOH). This indicates the condition of a battery pack and/or individual cells of the pack. SOH typically ranges from 0-100%, with 100% being the battery's specified operating condition. A battery pack's SOH will often be 100% at the time of manufacture and will decrease over time and use. However, a battery's performance at the time of manufacture may not meet specifications, in which case the initial SOH will be <100%. In any event, a BMS is responsible for determining and reporting current SOC, SOH, and other relevant status information for the battery pack.

In general, given SOH and/or SOC of a particular battery pack and a SOH and/or SOC thresholds of an application for an EV powered by the battery pack, it is possible to determine whether the EV is suitable for that application. In addition, given SOH and/or SOC of a battery pack, it is possible to determine and/or estimate the battery pack's useful lifetime for that application. In the context of shared-vehicle fleets (e.g., scooters), this information (along with any other relevant information about battery and/or EV) could facilitate better understanding of the capabilities and/or conditions of the fleet in a particular geographic area. However, current fleet management systems base decisions on dispatch, pickup, and distribution of vehicles primarily on knowledge of current locations of such vehicles. This can create various problems, issues, and/or difficulties in meeting end-user expectations and/or a service provider's cost requirements and/or logistics limitations.

Accordingly, embodiments of the present disclosure provide novel, flexible, and efficient techniques for management of shared-vehicle fleets (e.g., of EVs) by collecting various status information about the EVs and their battery packs and integrating the collected status information into determinations regarding dispatch, pickup, and distribution of vehicles over a service area. At a high level, the status information can be collected by wireless devices (e.g., user equipment, handheld devices, etc.) based on communication with the respective EVs and/or battery packs. Subsequently, the wireless devices can provide the collected information to a management server (e.g., a cloud service) that makes fleet management decisions for a service area based on the received status information in combination with vehicle location. In some embodiments, the management server can also make operational decisions for vehicles currently in use based on the status information and provide corresponding commands to the respective vehicles via the associated wireless devices.

Such embodiments can provide various benefits and/or advantages. For example, embodiments can improve end-user experience for vehicle-sharing services, such as by making available more vehicles with better capabilities and/or conditions in a geographic distribution according to user demand. As another example, embodiments can enable vehicle-sharing service providers to intelligently match vehicle usage patterns and/or conditions with the vehicle distribution in a service area. In this manner, the shared-vehicle service provider can enhance the total volume with optimal distributions of the vehicle dispatch in its overall service areas. Furthermore, some embodiments also enable the service provider to manage, reduce, and/or mitigate dangerous vehicle operational scenarios, thereby improving user safety and mitigating potential liability of the service provider.

High-level operation of various embodiments can be summarized as follows. A wireless device can be configured for short-range wireless communication with an EV (e.g., a host controller) and/or the EV's battery pack (e.g., the BMS), and for communication with a management service via a wide-area wireless network (e.g., cellular). The wireless device can be associated with a user of the vehicle, such that it can also be referred to as a “user equipment” (or UE). In some embodiments, the wireless device's display can function as the “dashboard” for the EV, thereby displaying various EV and/or battery status information of interest to the user.

Via the short-range wireless communication, the wireless device can access the real-time status information for the vehicle and battery, such as all manufacturer diagnostic data. The wireless device can send this status information to the management server via the wide-area wireless connection. In some embodiments, the status information can include the vehicle's current location (e.g., as determined by the wireless device). In other embodiments, the current location can be provided separate from the status information.

In some embodiments, the management server can establish a connection with the EV and/or the battery pack via the wireless device, but in a manner that is transparent to the wireless device. For example, the wireless device can be merely a conduit of status information from the short-range wireless connection to the wide-area wireless connection (or vice versa) without concern for the status information content. In other embodiments, the wireless device can include a management client that can retrieve the status information (i.e., via the short-range wireless connection(s)), possibly analyze or process it in some manner, and then send it to the management server (i.e., via the wide-area wireless network). Likewise, in these embodiments, the management client can receive a command from the management server, possibly analyze or processes it in some manner, and then send it to the vehicle and/or the battery.

Based on the collected status information, the management server can build and update each vehicle battery profile dynamically. For example, the management server can determine a service notification for a vehicle and/or the associated battery (e.g., manufacturer recall, normal service schedule, etc.). In some embodiments, based on the collected status information, the management server can send commands to the vehicle and/or the battery pack that control the vehicle's operations in some manner, such as dynamic enforcement of vehicle speed based on a speed limit associated with the current vehicle location (e.g., school area, pedestrian-only streets, busy commercial districts, etc.). For example, based on a speed limiting command, the BMS can limit the flow of current and/or energy from the battery pack to the vehicle.

In some embodiments, the management server can send a command to disable the flow of energy from the battery to the vehicle. This can be in response to an emergency (e.g., accidents, hazardous conditions, etc.), an immediate need for service of the vehicle and/or battery, or an indication that the vehicle has been stolen.

In some embodiments, the collected status information can include battery pack status information, such as SOC, SOH, usage profiles, etc. Based on this information, the management server can determine a preferred geographic distribution of the vehicles of the fleet in a service area. For example, the management server can determine that vehicle SOC tends to be lower in certain regions of the service area as compared to other regions of the service area. Based on this determination, the management server can decide to shift some number of vehicles from the higher-SOC region (and/or other regions) to the lower-SOC region. The management server can then dispatch redistribution operations in accordance with this decision. In this manner, the service provider can further enhance the service based on a more optimal distribution of available vehicles in a service area.

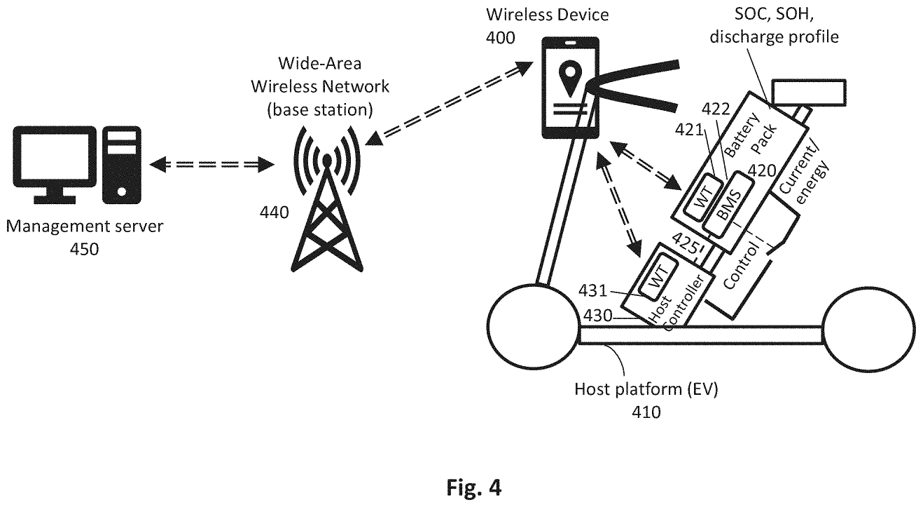

FIG. 4 shows an exemplary arrangement of communication between a wireless device, an EV host platform, and a management server, according to various exemplary embodiments of the present disclosure. In particular, FIG. 4 shows an EV 410 (which is illustrated as a scooter) that includes a battery pack 420 and a host controller 430. Battery pack 420 can include a BMS 422, which can communicate with host controller 430 over a communication bus 425. BMS 422 can also store a discharge profile for the cells comprising battery pack 420 and can determine a current SOC and a current state of health (SOH) for the battery pack. In general, BMS 422 can perform similar functions as other BMS discussed above, e.g., in relation to FIG. 1.

In some embodiments, battery pack 420 can also include a wireless transceiver (WT) 421. In some embodiments, host controller 431 can also include a WT 431. WTs 421 and 431 can include a short-range WT (e.g., Bluetooth, NFC, etc.) that can be used to communicate with proximate devices, such as wireless device 400 discussed below. In some embodiments, WT 431 can include a long-range WT (e.g., cellular) that can be used to communicate with a network node in a wide-area wireless network 440, illustrated in FIG. 4 as a base station. Examples of such network nodes are shown in and described in relation to other figures herein.

Wireless device 400 can be a user equipment (UE) including a WT (not shown), which is also referred to as a radio transceiver or radio transceiver circuitry. By using this WT, the wireless device can communicate with network 440 and with one or both of WTs 421 and 431. For example, wireless device 400's WT can include a short-range WT (e.g., Bluetooth, NFC, etc.) that can be used to communicate with proximate devices (such as WTs 421 and/or 431), and a long-range WT (e.g., cellular) that can be used to communicate with network 440. Wireless device 400 can also include a display and processing circuitry that can perform various operations. Examples of such wireless devices are shown in and described in relation to other figures herein.

Network 440 can also include, or be coupled to, a management server 450 that can be configured to perform fleet management operations according to various exemplary embodiments of the present disclosure. For example, management server 440 can receive status information associated with EV 410 and/or battery pack 420 from wireless device 400 via wide-area wireless network 440. In addition, management server 440 can send commands for EV 410 and/or battery pack 420 to wireless device 400 via wide-area wireless network 440. In some embodiments, management server 450 can communicate status information and commands via a corresponding management client (not shown), which can be installed on wireless device 400 or on host controller 430 and/or BMS 422. Management server 450 can also make various fleet management decisions and/or determinations based on the collected status information, as discussed elsewhere herein. Examples of management servers capable of performing such operations are shown in and described in relation to other figures herein.

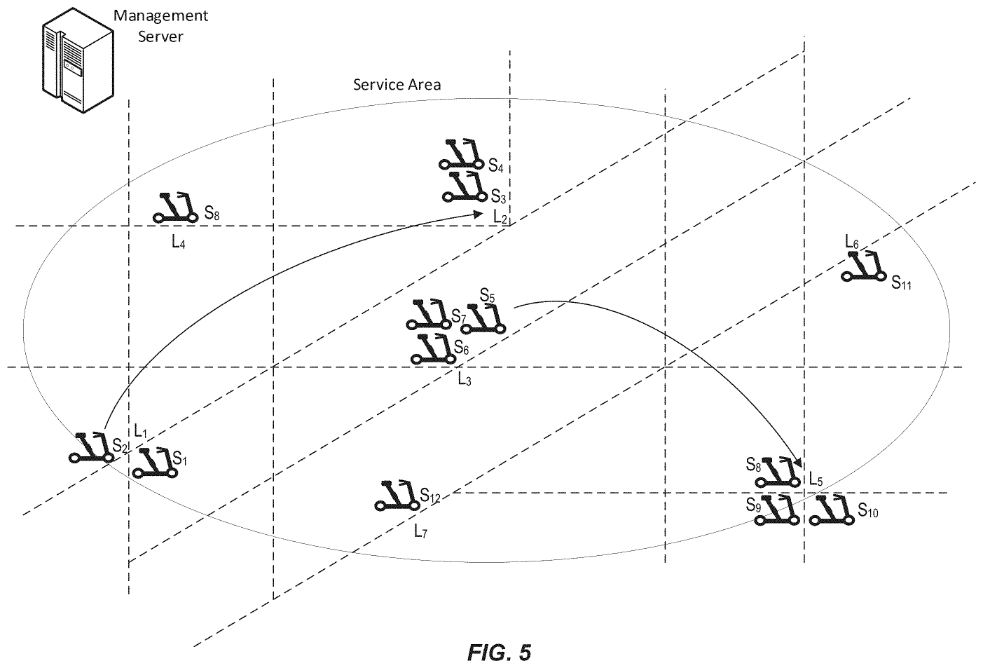

As mentioned above, based on collected status information (e.g., SOC, SOH, usage profiles, location, etc.) for the fleet of vehicles in a service area, a management server can determine a preferred geographic distribution of the vehicles in the service area. FIG. 5 shows an exemplary distribution of 12 EVs at seven (7) different locations within a service area. Roads or paths for vehicles in the service area are illustrated by dashed lines. Although the EVs shown in FIG. 5 are scooters, this type of EV is only used as an example of any EV capable of being used in a shared-vehicle service, including various EVs discussed herein.

Each EV i is associated with status information sᵢ, where i=1 . . . 12. Furthermore, each EV i can communicate sᵢ to the management server via respective wireless devices, e.g., associated with a user of EV i. Alternately, the management server can collect sᵢ when EV i is idle in an area or facility under control of the service provider, such as a charging station or a dispatch station. For example, such locations can have wireless LAN to communicate with EVs and a wide-area network backhaul connection (e.g., wired or wireless) to the management server.

As discussed herein, sᵢ can include various information associated with the i-th vehicle, such as battery SOC/SOH/discharge profile, manufacturer diagnostic data, usage history, etc. In some embodiments, sᵢ can also include the current location of vehicle i, as shown in FIG. 5. For example, the current location of EVs 1 and 2 is L₁, the current location of EVs 3 and 4 is L₂, etc. However, the respective current locations can be communicated separately from the status information, as needed.

Based on the collected status information sᵢ (i=1 . . . 12), the management server can determine that locations L₂ and L₅ have insufficient numbers of EVs to meet user demand. For example, the management server can determine that even though L₅ has a relatively large number of EVs, the SOC and/or SOH of these EVs are insufficient to meet user demand for the service in the region surrounding L₅. This can be determined based on comparing SOC and/or SOH statistics for the EVs at L₅ to a threshold, which can be based on a usage profile, etc. If the statistic is less than the threshold, the management server can determine that the number of EVs at L₅ should be increased. A similar determination can be made with respect to L₂.

Based on the collected status information sᵢ (i=1 . . . 12), the management server also can determine that locations L₁ and L₃ currently have more than enough EVs to meet user demand in the regions surrounding these respective locations. For example, the management server can determine that the EVs in the region around L₃ tend to have a very good SOC and/or SOH relative to user demand, such that very few extra EVs need to be available at L₃ for swapping. This can be determined based on comparing SOC and/or SOH statistics for the EVs at (or around) L₃ to a threshold, which can be based on a usage profile, etc. If the statistic is greater than the threshold, the management server can determine that the number of EVs at L₃ should be decreased. A similar determination can be made with respect to L₁.

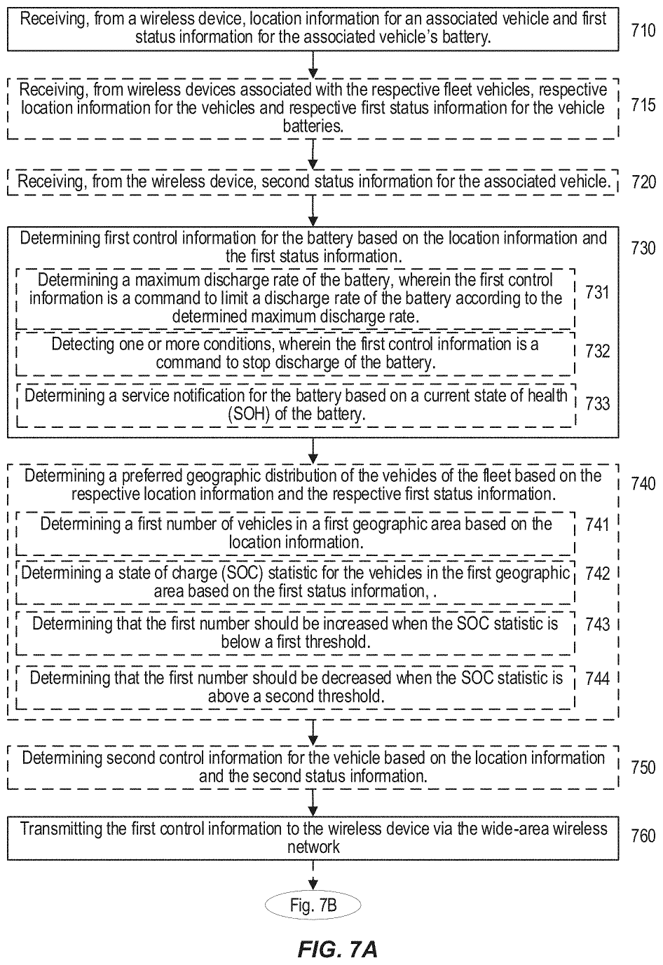

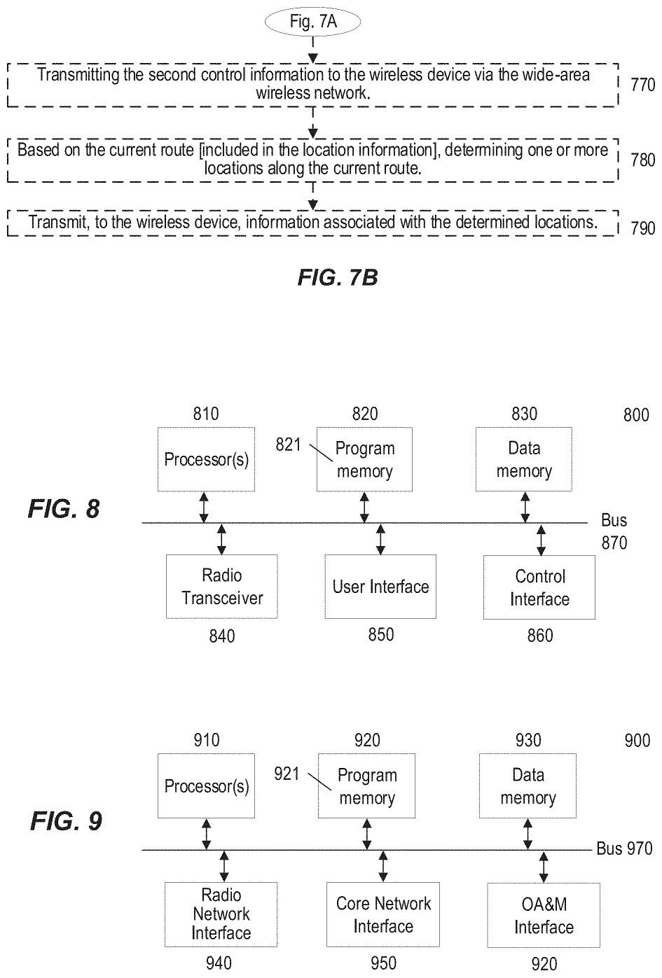

Based on these determinations for L₁, L₂, L₃, and L₅, the management server can also determine that one EV (e.g., EV2) should be moved from L₁ to L₂, and that one EV (e.g., EV5) should be moved from L₃ to L₅. This is illustrated in FIG. 7 by the curved solid lines. The management server can then dispatch redistribution operations according to this determination.

In some embodiments, the wireless device can also send location information concerning a user's stating point and destination (e.g., for a route) when using a vehicle provided by the shared-vehicle service. In some embodiments, the location information can also include the user's route (e.g., based on user selection). Based on this location information, the management server can determine one or more locations along the route, e.g., associated with businesses or services. The management server can then send information associated with the locations (e.g., names/addresses/phone numbers/URLs of the businesses, information about services offered, etc.) to the wireless device, which can display such information to the user. In this manner, the management server can provide location-based targeted advertising in association with the vehicle-sharing service.

As mentioned above, the wireless device may be associated with a user of the shared-vehicle service, while the collection of status information and provision of commands for fleet management is primarily for the benefit of the service provider. In some embodiments, the service provider's use of user devices in this manner can be part of the terms and conditions that users must agree to when signing up for the shared-vehicle service (e.g., either with or without explicit opt-in consent). Alternately, the service provider's use of user devices in this manner can be part of the terms and conditions for an enhancement to the shared-vehicle service, such as vehicle swap.

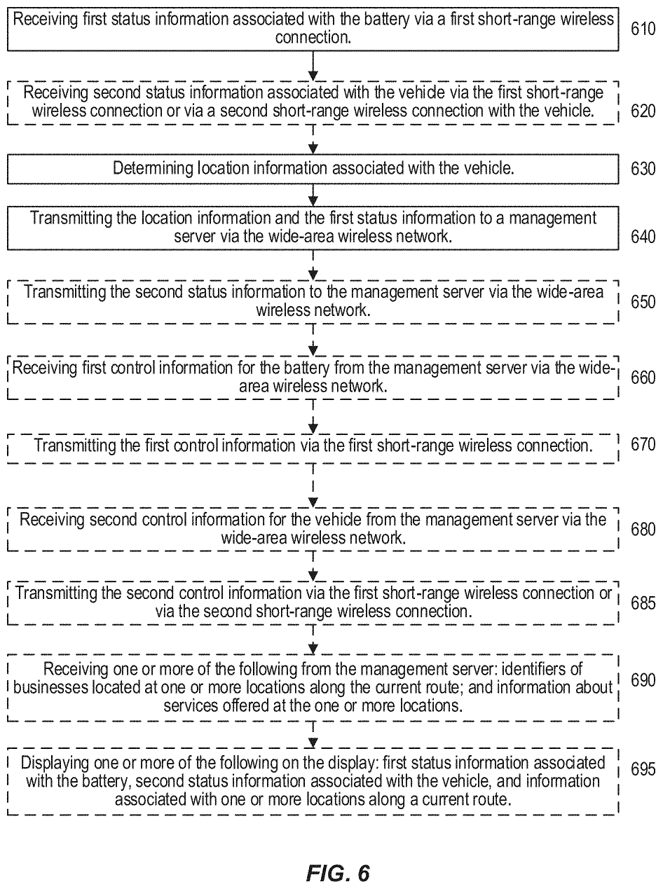

The embodiments described above can be further illustrated with reference to FIGS. 6-7, which show exemplary methods (e.g., procedures) for a wireless device and a management server, respectively. Put differently, various features of the operations described below correspond to various embodiments described above. Furthermore, the exemplary methods shown in FIGS. 6-7 can be used cooperatively to provide various exemplary benefits, advantages, and/or solutions to problems described herein. Although FIGS. 6-7 show specific blocks in particular orders, the operations of the exemplary methods can be performed in different orders than shown and can be combined and/or divided into blocks with different functionality than shown. Optional blocks or operations are indicated by dashed lines.

In particular, FIG. 6 shows a flow diagram of an exemplary method (e.g., procedure) for a wireless device configured for use with a battery-powered vehicle, according to various exemplary embodiments of the present disclosure. For example, the exemplary method shown in FIG. 6 can be implemented in a wireless device (e.g., user equipment) configured according to other figures described herein.

The exemplary method can include the operations of block 610, where the wireless device can receive first status information associated with the battery via a first short-range wireless connection. The exemplary method can also include the operations of block 630, where the wireless device can determine location information associated with the vehicle. In various embodiments, the vehicle can be a car, a truck, a scooter, or a motorcycle. The exemplary method can also include the operations of block 640, where the wireless device can transmit the location information and the first status information to a management server via the wide-area wireless network.

In some embodiments, the first status information includes one or more of the following: current state of charge (SOC), current state of health (SOH), over temperature (OT) indicator, and one or more error code (EC) counters.

In some embodiments, the exemplary method can also include the operations of blocks 660-670. In block 660, the wireless device can receive first control information for the battery from the management server via the wide-area wireless network. In block 670, the wireless device can transmit the first control information via the first short-range wireless connection. In some embodiments, the first control information can be based on the location information and the first status information.

In some embodiments, the first control information can include one or more of the following: a command to limit a discharge rate of the battery; a command to stop discharge of the battery; and a service notification for the battery. In some of these embodiments, the command to limit the discharge rate can be based on one or more of the following: a maximum allowed speed at a current vehicle location, an indication of high vehicle and/or pedestrian traffic at the current vehicle location, and a current SOC of the battery.

As specific examples, the command to limit the discharge rate could be based on an indication of a pedestrian zone (e.g., an area of high pedestrian traffic with few vehicles) or a school zone with high pedestrian traffic and reduced speed limits during certain times of day. As another example, the command to limit the discharge rate could be based on an indication (e.g., from traffic cameras, other fleet vehicles, etc.) of traffic congestion in an intersection that an EV is approaching.

In other of these embodiments, a command to stop discharge of the battery can be based on one or more of the following:
danger or hazard associated with the current vehicle location,
an indication that the vehicle has been stolen,
a current SOH of the battery,
OT indicator, and
one or more EC counters exceeding respective thresholds.

In some embodiments, the exemplary method can also include the operations of blocks 650 and 680. In block 650, the wireless device can transmit second status information associated with the vehicle to the management server via the wide-area wireless network. In block 680, the wireless device can receive second control information for the vehicle from the management server via the wide-area wireless network.

In some of these embodiments, the second status information can include one or more of the following: total usage for the vehicle, usage since the most recent service to the vehicle, total cycles of the battery, vehicle error codes, and vehicle accelerometer records. In some of these embodiments, the second control information can include a service notification and/or an alarm notification.

In some of these embodiments, the exemplary method can also include the operations of blocks 620 and 685. In block 620, the wireless device can receive the second status information via the first short-range wireless connection or via a second short-range wireless connection with the vehicle (e.g., before transmitting the second status information in block 650). In block 685, the wireless device can transmit the second control information via the first short-range wireless connection or via the second short-range wireless connection (e.g., after receiving the second control information in block 680).

In some of these embodiments, the first short-range wireless connection can be between the wireless device and a BMS arranged to control the battery. In such embodiments, wireless device can receive the second status information and transmit the second control information via the second short-range wireless connection.

In other of these embodiments, the first short-range wireless connection can be between the wireless device and the vehicle. In such embodiments, wireless device can receive the second status information and transmit the second control information via the first short-range wireless connection.

In some embodiments, the location information (e.g., determined in block 630) can include one or more of the following: current location, one or more past locations, current speed, one or more past speeds, current heading, current route, and starting point and destination for a current route. In some of these embodiments (e.g., when the location information includes a current route), the exemplary method can also include the operations of block 690, where the wireless device can receive one or more of the following from the management server: identifiers of businesses located at one or more locations along the current route and/or information about services offered at the one or more locations.

In some embodiments, the exemplary method can also include the operations of block 695, where the wireless device can display at least a portion of the following on a display associated with the wireless device: the first status information associated with the battery, second status information associated with the vehicle, and information associated with one or more locations along a current route.

In addition, FIG. 7 (which includes FIGS. 7A-7B) show a flow diagram of an exemplary method (e.g., procedure) for managing one or more vehicles (e.g., car, truck, scooter, motorcycle, etc.) powered by batteries, according to various exemplary embodiments of the present disclosure. For example, the exemplary method shown in FIG. 7 can be implemented by a management server (e.g., for fleet management) configured according to other figures described herein.

The exemplary method can include the operations of block 710, where the management server can receive, from a wireless device via a wide-area wireless network, location information for a vehicle associated with the wireless device and first status information for the associated vehicle's battery. The exemplary method can include the operations of block 730, where the management server can determine first control information for the battery based on the location information and the first status information. The exemplary method can include the operations of block 760, where the management server can transmit the first control information to the wireless device via the wide-area wireless network.

In some embodiments, the first status information includes one or more of the following: current SOC, current SOH, OT indicator, and one or more EC counters. In some embodiments, the location information can include one or more of the following: current location, one or more past locations, current speed, one or more past speeds, current heading, current route, and starting point and destination for the current route.

In some embodiments, determining the first control information in block 730 can include the operations of sub-block 731, where the management server can determine a maximum discharge rate of the battery based on a maximum allowed speed at a current vehicle location, an indication of high vehicle and/or pedestrian traffic at the current vehicle location, and/or a current SOC of the battery. Some example scenarios were discussed above in relation to the UE embodiments. In such embodiments, the first control information can include a command to limit a discharge rate of the battery according to the determined maximum discharge rate.

In other embodiments, determining the first control information in block 730 can include the operations of sub-block 732, where the management server can detect one or more of the following:
a danger or hazard associated with the current vehicle location,
an indication that the vehicle has been stolen,
the current SOH of the battery is below a minimum operational threshold,
one or more EC counters have exceeded respective thresholds, and
an OT indication.
   In such embodiments, the first control information can include a command to stop discharge of the battery.

In other embodiments, determining the first control information in block 730 can include the operations of sub-block 733, where the management server can determine a service notification for the battery based on a current SOH of the battery.

In some embodiments, the exemplary method can also include the operations of blocks 720, 750, and 770. In block 720, the management server can receive, from the wireless device, second status information for the associated vehicle. In block 750, the management server can determine second control information for the vehicle based on the location information and the second status information. In block 770, the management server can transmit the second control information to the wireless device via the wide-area wireless network.

In some of these embodiments, the first control information can also be determined (e.g., in block 730) based on the second status information and/or the second control information can also be determined (e.g., in block 750) based on the first status information.

In some of these embodiments, the second status information includes one or more of the following: total usage for the vehicle, usage since the most recent service to the vehicle, total cycles of the battery, vehicle error codes, and vehicle accelerometer records. In some of these embodiments, the second control information can include a service notification and/or an alarm notification.

In some embodiments, the one or more vehicles comprises a fleet of vehicles (e.g., owned and/or managed by a single entity). In such embodiments, the exemplary method can also include the operations of blocks 715 and 740. In block 715, the management server can receive, from wireless devices associated with the respective vehicles, respective location information for the vehicles and respective first status information for the vehicle batteries. The operation of block 710 (e.g., receiving from a single wireless device) can be part of block 715, or it can be a separate operation as shown in FIG. 7. In block 740, the management server can determine a preferred geographic distribution of the fleet of vehicles of based on the respective location information and the respective first status information.

In some embodiments, determining the preferred geographic distribution in block 740 can include the operations of sub-blocks 741-743. In sub-block 741, the management server can determine that a first number of vehicles are in a first geographic area based on the location information. In sub-block 742, the management server can determine a SOC statistic for the vehicles in the first geographic area based on the first status information. In various embodiments, the SOC statistic can be one of the following: mean, median, minimum, or maximum. In sub-block 743, the management server can determine that the first number should be increased when the SOC statistic is below a first threshold. In some embodiments, determining the preferred geographic distribution in block 740 can also include the operations of sub-block 744, where the management server can determine that the first number should be decreased when the SOC statistic is above a second threshold.

In some embodiments, the location information can include a current route. In such embodiments, the exemplary method can also include the operations of blocks 780-790. In block 780, the management server can determine one or more locations along the current route. In block 790, the management server can send, to the wireless device, identifiers of businesses located at the one or more locations and/or information about services offered at the one or more locations.

Although FIGS. 6-7 illustrate exemplary methods (e.g., procedures), the operations corresponding to these methods (including any blocks and sub-blocks) can also be embodied in a non-transitory, computer-readable medium storing computer-executable instructions. The operations corresponding to these methods (including any blocks and sub-blocks) can also be embodied in a computer program product storing computer-executable instructions. In either case, when such instructions are executed by processing circuitry associated with a wireless device or a management server, they can configure the respective entities to perform operations corresponding to the methods of FIGS. 6-7, respectively. Some example implementations are described in more detail below.

Long Term Evolution (LTE) is an umbrella term for so-called fourth-generation (4G) radio access technologies developed within the Third-Generation Partnership Project (3GPP) and initially standardized in Release 8 (Rel-8) and Release 9 (Rel-9), also known as Evolved UTRAN (E-UTRAN). LTE is targeted at various licensed frequency bands and is accompanied by improvements to non-radio aspects commonly referred to as System Architecture Evolution (SAE), which includes Evolved Packet Core (EPC) network. LTE continues to evolve through subsequent releases.

LTE Rel-10 supports bandwidths larger than 20 MHz. One important requirement on Rel-10 is to backward compatibility with LTE Rel-8. This also includes spectrum compatibility in which a wideband LTE Rel-10 carrier (e.g., wider than 20 MHz) should appear as multiple carriers to an LTE Rel-8 (“legacy”) terminal (“user equipment” or UE). Each such carrier can be referred to as a Component Carrier (CC). For efficient usage, legacy terminals can be scheduled in all parts of the wideband LTE Rel-10 carrier. This can be done by Carrier Aggregation (CA), in which a Rel-10 terminal receives multiple CCs, each having the same structure as a Rel-8 carrier. LTE Rel-12 introduced dual connectivity (DC) whereby a UE can be connected to two network nodes simultaneously, thereby improving connection robustness and/or capacity.

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

Fifth-generation NR technology shares many similarities with fourth-generation LTE. For example, NR uses CP-OFDM (Cyclic Prefix Orthogonal Frequency Division Multiplexing) in the downlink (DL) and both CP-OFDM and DFT-spread OFDM (DFT-S-OFDM) in the uplink (UL). As another example, in the time domain, NR DL and UL physical resources are organized into equal-sized 1-ms subframes. A subframe is further divided into multiple slots of equal duration, with each slot including multiple OFDM-based symbols. In addition to providing coverage via cells, as in LTE, NR networks also provide coverage via “beams.” In general, a DL “beam” is a coverage area of a network-transmitted RS that may be measured or monitored by a user equipment (UE, e.g., wireless device).

To support increased traffic capacity and to enable the transmission bandwidth needed to support very high data rate services, 5G will extend the range of frequencies used for mobile communication. This includes new spectrum below 6 GHz (referred to as “FR1”), as well as spectrum in higher frequency bands above 24 GHz (referred to as “FR2”).

3GPP standards provide various ways for positioning (e.g., determining the position of, locating, and/or determining the location of) UEs operating in LTE networks. In general, an LTE positioning node (referred to as “E-SMLC” or “location server”) configures the target device (e.g., UE), an eNB, or a radio network node dedicated for positioning measurements (e.g., a “location measurement unit” or “LMU”) to perform one or more positioning measurements according to one or more positioning methods. For example, the positioning measurements can include timing (and/or timing difference) measurements on UE, network, and/or satellite transmissions. The positioning measurements are used by the target device (e.g., UE), the measuring node, and/or the E-SMLC to determine the location of the target device.

UE positioning is also expected to be an important feature for NR networks, which will support positioning methods similar to those in LTE but based on NR measurements. NR may also support other position methods such as downlink angle of departure (DL-AoD), uplink angle of arrival (UL-AoA), and multiple round-trip-time (Multi-RTT).

FIG. 8 shows a block diagram of an exemplary wireless device or user equipment (UE) 800 (hereinafter referred to as “UE 800”) according to various embodiments of the present disclosure, including those described above with reference to other figures. For example, UE 800 can be configured by execution of instructions, stored on a computer-readable medium, to perform operations corresponding to the exemplary methods discussed above in relation to FIG. 6.

UE 800 can include a processor 810 (also referred to as “processing circuitry”) that can be operably connected to a program memory 820 and/or a data memory 830 via a bus 870 that can comprise parallel address and data buses, serial ports, or other methods and/or structures known to those of ordinary skill in the art. Program memory 820 can store software code, programs, and/or instructions (collectively shown as computer program product 821 in FIG. 8) that, when executed by processor 810, can configure and/or facilitate UE 800 to perform various operations, including operations corresponding to various exemplary methods described herein. As part of or in addition to such operations, execution of such instructions can configure and/or facilitate UE 800 to communicate using one or more wired or wireless communication protocols, including one or more wireless communication protocols standardized by 3GPP, IEEE, or other standards-setting organizations (SSOs). Such protocols include those commonly known as 5G (including NR and NR-Unlicensed), 4G (including LTE, LTE-Advanced, LTE-LAA, etc.), 3G (including UMTS, HSPA, etc.), 2G (including GSM, GPRS, EDGE, 1×RTT, CDMA2000, etc.), 802.11 WiFi (and variants), HDMI, USB, Firewire, etc. However, skilled persons will recognize that there may be other current or future protocols compatible for use with radio transceiver 840, user interface 850, and/or control interface 860.

As another example, processor 810 can execute program code stored in program memory 820 that corresponds to MAC, RLC, PDCP, and RRC layer protocols standardized by 3GPP (e.g., for 4G, 5G, etc.). As a further example, processor 810 can execute program code stored in program memory 820 that, together with radio transceiver 840, implements corresponding PHY layer protocols, such as Orthogonal Frequency Division Multiplexing (OFDM), Orthogonal Frequency Division Multiple Access (OFDMA), and Single-Carrier Frequency Division Multiple Access (SC-FDMA). As another example, processor 810 can execute program code stored in program memory 820 that, together with radio transceiver 840, implements device-to-device (D2D) communications with other compatible devices and/or UEs.

Program memory 820 can also include software code executed by processor 810 to control the functions of UE 800, including configuring and controlling various components such as radio transceiver 840, user interface 850, and/or control interface 860. Program memory 820 can also comprise one or more application programs and/or modules comprising computer-executable instructions embodying any of the exemplary methods described herein. Such software code can be specified or written using any known or future developed programming language, such as e.g., Java, C++, C, Objective C, HTML, XHTML, machine code, and Assembler, as long as the desired functionality, e.g., as defined by the implemented method steps, is preserved. In addition, or as an alternative, program memory 820 can comprise an external storage arrangement (not shown) remote from UE 800, from which the instructions can be downloaded into program memory 820 located within or removably coupled to UE 800, so as to enable execution of such instructions.

Data memory 830 can include memory area for processor 810 to store variables used in protocols, configuration, control, and other functions of UE 800, including operations corresponding to, or comprising, any of the exemplary methods described herein. Moreover, program memory 820 and/or data memory 830 can include non-volatile memory (e.g., flash memory), volatile memory (e.g., static or dynamic RAM), or a combination thereof. Furthermore, data memory 830 can comprise a memory slot by which removable memory cards in one or more formats (e.g., SD Card, Memory Stick, Compact Flash, etc.) can be inserted and removed.

Persons of ordinary skill will recognize that processor 810 can include multiple individual processors (including, e.g., multi-core processors), each of which implements a portion of the functionality described above. In such cases, multiple individual processors can be commonly connected to program memory 820 and data memory 830 or individually connected to multiple individual program memories and or data memories. More generally, persons of ordinary skill in the art will recognize that various protocols and other functions of UE 800 can be implemented in many different computer arrangements comprising different combinations of hardware and software including, but not limited to, application processors, signal processors, general-purpose processors, multi-core processors, ASICs, fixed and/or programmable digital circuitry, analog baseband circuitry, radio-frequency circuitry, software, firmware, and middleware.

Radio transceiver 840 can include radio-frequency transmitter and/or receiver functionality that facilitates the UE 800 to communicate with other equipment supporting like wireless communication standards and/or protocols. In some exemplary embodiments, the radio transceiver 840 includes one or more transmitters and one or more receivers that enable UE 800 to communicate according to various protocols and/or methods proposed for standardization by 3GPP and/or other standards bodies. For example, such functionality can operate cooperatively with processor 810 to implement a PHY layer based on OFDM, OFDMA, and/or SC-FDMA technologies, such as described herein with respect to other figures.

In some exemplary embodiments, radio transceiver 840 includes one or more transmitters and one or more receivers that can facilitate the UE 800 to communicate with various LTE, LTE-Advanced (LTE-A), and/or NR networks according to standards promulgated by 3GPP. In some exemplary embodiments of the present disclosure, the radio transceiver 840 includes circuitry, firmware, etc. necessary for the UE 800 to communicate with various NR, NR-U, LTE, LTE-A, LTE-LAA, UMTS, and/or GSM/EDGE networks, also according to 3GPP standards. In some embodiments, radio transceiver 840 can include circuitry supporting D2D communications between UE 800 and other compatible devices.

In some embodiments, radio transceiver 840 includes circuitry, firmware, etc. necessary for the UE 800 to communicate with various CDMA2000 networks, according to 3GPP2 standards. In some embodiments, the radio transceiver 840 can be capable of communicating using radio technologies that operate in unlicensed frequency bands, such as IEEE 802.11 WiFi that operates using frequencies in the regions of 2.4, 5.6, and/or 60 GHz. In some embodiments, radio transceiver 840 can include a transceiver that is capable of wired communication, such as by using IEEE 802.3 Ethernet technology. The functionality particular to each of these embodiments can be coupled with and/or controlled by other circuitry in the UE 800, such as the processor 810 executing program code stored in program memory 820 in conjunction with, and/or supported by, data memory 830.

User interface 850 can take various forms depending on the particular embodiment of UE 800, or can be absent from UE 800 entirely. In some embodiments, user interface 850 can comprise a microphone, a loudspeaker, slidable buttons, depressible buttons, a display, a touchscreen display, a mechanical or virtual keypad, a mechanical or virtual keyboard, and/or any other user-interface features commonly found on mobile phones. In other embodiments, the UE 800 can comprise a tablet computing device including a larger touchscreen display. In such embodiments, one or more of the mechanical features of the user interface 850 can be replaced by comparable or functionally equivalent virtual user interface features (e.g., virtual keypad, virtual buttons, etc.) implemented using the touchscreen display, as familiar to persons of ordinary skill in the art. In other embodiments, the UE 800 can be a digital computing device, such as a laptop computer, desktop computer, workstation, etc. that comprises a mechanical keyboard that can be integrated, detached, or detachable depending on the particular exemplary embodiment. Such a digital computing device can also comprise a touch screen display. Many exemplary embodiments of the UE 800 having a touch screen display are capable of receiving user inputs, such as inputs related to exemplary methods described herein or otherwise known to persons of ordinary skill.

In some embodiments, UE 800 can include an orientation sensor, which can be used in various ways by features and functions of UE 800. For example, the UE 800 can use outputs of the orientation sensor to determine when a user has changed the physical orientation of the UE 800's touch screen display. An indication signal from the orientation sensor can be available to any application program executing on the UE 800, such that an application program can change the orientation of a screen display (e.g., from portrait to landscape) automatically when the indication signal indicates an approximate 80-degree change in physical orientation of the device. In this exemplary manner, the application program can maintain the screen display in a manner that is readable by the user, regardless of the physical orientation of the device. In addition, the output of the orientation sensor can be used in conjunction with various exemplary embodiments of the present disclosure.

A control interface 860 of the UE 800 can take various forms depending on the particular exemplary embodiment of UE 800 and of the particular interface requirements of other devices that the UE 800 is intended to communicate with and/or control. For example, the control interface 860 can comprise an RS-232 interface, a USB interface, an HDMI interface, a Bluetooth interface, a near-field communications (NFC) interface, an IEEE (“Firewire”) interface, an I²C interface, a PCMCIA interface, or the like. In some exemplary embodiments of the present disclosure, control interface 860 can comprise an IEEE 802.3 Ethernet interface such as described above. In some exemplary embodiments of the present disclosure, the control interface 860 can comprise analog interface circuitry including, for example, one or more digital-to-analog converters (DACs) and/or analog-to-digital converters (ADCs).

In certain embodiments, UE 800 can use control interface 860 for short-range wireless communications with other compatible devices. For example, when control interface 860 includes Bluetooth and/or NFC interfaces, UE 800 can communicate with proximate devices having compatible Bluetooth and/or NFC interfaces. Such communication can facilitate various operations by UE 800, such as in relation to various methods (e.g., procedures) described herein.

Persons of ordinary skill in the art can recognize the above list of features, interfaces, and radio-frequency communication standards is merely exemplary, and not limiting to the scope of the present disclosure. In other words, the UE 800 can comprise more functionality than is shown in FIG. 8 including, for example, a video and/or still-image camera, microphone, media player and/or recorder, etc. Moreover, radio transceiver 840 can include circuitry necessary to communicate using additional radio-frequency communication standards including Bluetooth, GPS, and/or others. Moreover, the processor 810 can execute software code stored in the program memory 820 to control such additional functionality. For example, directional velocity and/or position estimates output from a GPS receiver can be available to any application program executing on the UE 800, including any program code corresponding to and/or embodying any exemplary embodiments (e.g., of methods) described herein.

FIG. 9 shows a block diagram of an exemplary network node 900 according to various embodiments of the present disclosure, including those described above with reference to other figures. For example, exemplary network node 900 can be configured by execution of instructions, stored on a computer-readable medium, to perform operations corresponding to one or more of the exemplary methods described herein. In some exemplary embodiments, network node 900 can comprise a base station, eNB, gNB, or one or more components thereof. For example, network node 900 can be configured as a central unit (CU) and one or more distributed units (DUs) according to NR gNB architectures specified by 3GPP. More generally, the functionally of network node 900 can be distributed across various physical devices and/or functional units, modules, etc.

Network node 900 can include processor 910 (also referred to as “processing circuitry”) that is operably connected to program memory 920 and data memory 930 via bus 970, which can include parallel address and data buses, serial ports, or other methods and/or structures known to those of ordinary skill in the art.

Program memory 920 can store software code, programs, and/or instructions (collectively shown as computer program product 921 in FIG. 9) that, when executed by processor 910, can configure and/or facilitate network node 900 to perform various operations, including operations corresponding to various exemplary methods described herein. As part of and/or in addition to such operations, program memory 920 can also include software code executed by processor 910 that can configure and/or facilitate network node 900 to communicate with one or more other UEs or network nodes using other protocols or protocol layers, such as one or more of the PHY, MAC, RLC, PDCP, and RRC layer protocols standardized by 3GPP for LTE, LTE-A, and/or NR, or any other higher-layer (e.g., NAS) protocols utilized in conjunction with radio network interface 940 and/or core network interface 950. By way of example, core network interface 950 can comprise the S1 or NG interface and radio network interface 940 can comprise the Uu interface, as standardized by 3GPP. Program memory 920 can also comprise software code executed by processor 910 to control the functions of network node 900, including configuring and controlling various components such as radio network interface 940 and core network interface 950.

Data memory 930 can comprise memory area for processor 910 to store variables used in protocols, configuration, control, and other functions of network node 900. As such, program memory 920 and data memory 930 can comprise non-volatile memory (e.g., flash memory, hard disk, etc.), volatile memory (e.g., static or dynamic RAM), network-based (e.g., “cloud”) storage, or a combination thereof. Persons of ordinary skill in the art will recognize that processor 910 can include multiple individual processors (not shown), each of which implements a portion of the functionality described above. In such case, multiple individual processors may be commonly connected to program memory 920 and data memory 930 or individually connected to multiple individual program memories and/or data memories. More generally, persons of ordinary skill will recognize that various protocols and other functions of network node 900 may be implemented in many different combinations of hardware and software including, but not limited to, application processors, signal processors, general-purpose processors, multi-core processors, ASICs, fixed digital circuitry, programmable digital circuitry, analog baseband circuitry, radio-frequency circuitry, software, firmware, and middleware.

Radio network interface 940 can comprise transmitters, receivers, signal processors, ASICs, antennas, beamforming units, and other circuitry that enables network node 900 to communicate with other equipment such as, in some embodiments, a plurality of compatible user equipment (UE). In some embodiments, interface 940 can also enable network node 900 to communicate with compatible satellites of a satellite communication network. In some exemplary embodiments, radio network interface 940 can comprise various protocols or protocol layers, such as the PHY, MAC, RLC, PDCP, and/or RRC layer protocols standardized by 3GPP for LTE, LTE-A, LTE-LAA, NR, NR-U, etc.; improvements thereto such as described herein above; or any other higher-layer protocols utilized in conjunction with radio network interface 940. According to further exemplary embodiments of the present disclosure, the radio network interface 940 can comprise a PHY layer based on OFDM, OFDMA, and/or SC-FDMA technologies. In some embodiments, the functionality of such a PHY layer can be provided cooperatively by radio network interface 940 and processor 910 (including program code in memory 920).

Core network interface 950 can comprise transmitters, receivers, and other circuitry that enables network node 900 to communicate with other equipment in a core network such as, in some embodiments, circuit-switched (CS) and/or packet-switched Core (PS) networks. In some embodiments, core network interface 950 can comprise the S1 interface standardized by 3GPP. In some embodiments, core network interface 950 can comprise the NG interface standardized by 3GPP. In some exemplary embodiments, core network interface 950 can comprise one or more interfaces to one or more AMFs, SMFs, SGWs, MMEs, SGSNs, GGSNs, and other physical devices that comprise functionality found in GERAN, UTRAN, EPC, 5GC, and CDMA2000 core networks that are known to persons of ordinary skill in the art. In some embodiments, these one or more interfaces may be multiplexed together on a single physical interface. In some embodiments, lower layers of core network interface 950 can comprise one or more of asynchronous transfer mode (ATM), Internet Protocol (IP)-over-Ethernet, SDH over optical fiber, T1/E1/PDH over a copper wire, microwave radio, or other wired or wireless transmission technologies known to those of ordinary skill in the art.

In some embodiments, network node 900 can include hardware and/or software that configures and/or facilitates network node 900 to communicate with other network nodes in a RAN, such as with other eNBs, gNBs, ng-eNBs, en-gNBs, IAB nodes, etc. Such hardware and/or software can be part of radio network interface 940 and/or core network interface 950, or it can be a separate functional unit (not shown). For example, such hardware and/or software can configure and/or facilitate network node 900 to communicate with other RAN nodes via the X2 or Xn interfaces, as standardized by 3GPP.

OA&M interface 960 can comprise transmitters, receivers, and other circuitry that enables network node 900 to communicate with external networks, computers, databases, and the like for purposes of operations, administration, and maintenance of network node 900 or other network equipment operably connected thereto. Lower layers of OA&M interface 960 can comprise one or more of asynchronous transfer mode (ATM), Internet Protocol (IP)-over-Ethernet, SDH over optical fiber, T1/E1/PDH over a copper wire, microwave radio, or other wired or wireless transmission technologies known to those of ordinary skill in the art. Moreover, in some embodiments, one or more of radio network interface 940, core network interface 950, and OA&M interface 960 may be multiplexed together on a single physical interface, such as the examples listed above.

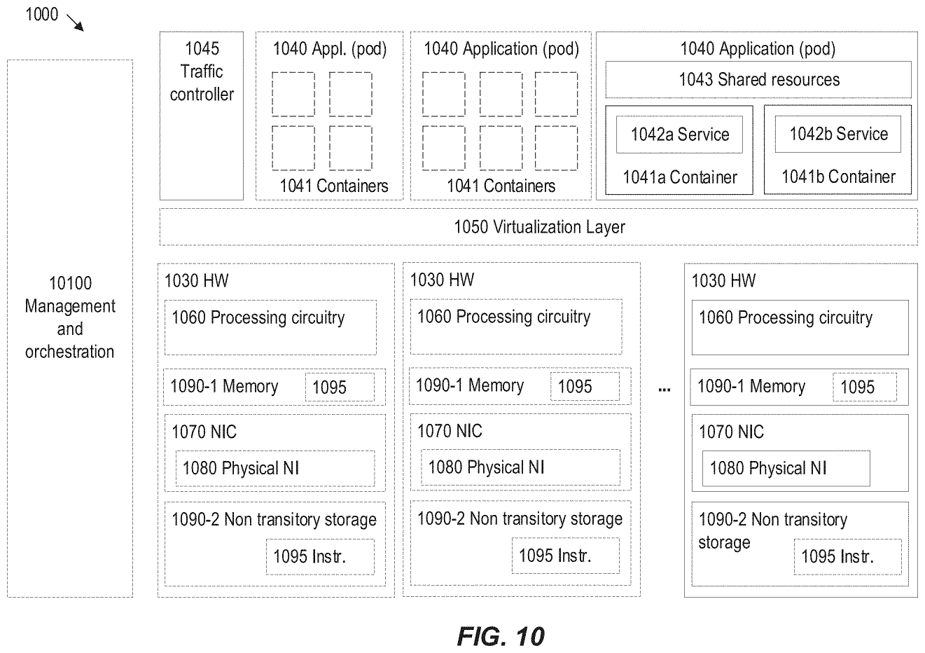

FIG. 10 is a schematic block diagram illustrating a virtualization environment 1000 suitable for implement various embodiments of a management server. In other words, the operations described herein as being performed by a management server (e.g., the exemplary method illustrated by FIG. 7) can be performed by the hardware and software of virtualization environment 1000, described below.

For example, some or all of the functions described herein can be implemented as virtual components executed by one or more virtual machines implemented in virtual environment 1000 hosted by one or more of hardware nodes 1030. Such hardware nodes can be computing machines arranged in a cluster (e.g., such as in a data center or customer premise equipment (CPE)) where many hardware nodes work together and are managed via management and orchestration (MANO) 10100, which, among others, oversees lifecycle management of applications 1040. In some embodiments, however, such virtual components can be executed by one or more physical computing machines, e.g., without (or with less) virtualization of the underlying resources of hardware nodes 1030.

Hardware nodes 1030 can include processing circuitry 1060 and memory 1090. Memory 1090 contains instructions 1095 executable by processing circuitry 1060 whereby application 1040 can be operative for various features, functions, procedures, etc. of the embodiments disclosed herein. Processing circuitry 1060 can include general-purpose or special-purpose hardware devices such as one or more processors (e.g., custom and/or commercial off-the-shelf), dedicated Application Specific Integrated Circuits (ASICs), or any other type of processing circuitry including digital or analog hardware components or special purpose processors. Each hardware node can comprise memory 1090-1 which can be non-persistent memory for temporarily storing instructions 1095 or software executed by processing circuitry 1060. For example, instructions 1095 can include program instructions (also referred to as a computer program product) that, when executed by processing circuitry 1060, can configure hardware node 1020 to perform operations corresponding to the methods/procedures described herein.

Each hardware node can comprise one or more network interface controllers (NICs)/network interface cards 1070, which include physical network interface 1080. Each hardware node can also include non-transitory, persistent, machine-readable storage media 1090-2 having stored therein software 1095 and/or instructions executable by processing circuitry 1060. Software 1095 can include any type of software including software for instantiating one or more optional virtualization layers/hypervisors 1050, and software to execute applications 1040.

In some embodiments, virtualization layer 1050 can be used to provide VMs that are abstracted from the underlying hardware nodes 1030. In such embodiments, processing circuitry 1060 executes software 1095 to instantiate virtualization layer 1050, which can sometimes be referred to as a virtual machine monitor (VMM). For example, virtualization layer 1050 can present a virtual operating platform that appears like networking hardware to containers and/or pods hosted by environment 1000. Moreover, each VM (e.g., as facilitated by virtualization layer 1050) can manifest itself as a software implementation of a physical machine that runs programs as if they were executing on a physical, non-virtualized machine. Each VM can have dedicated hardware nodes 1030 or can share resources of one or more hardware nodes 1030 with other VMs.

Various applications 1040 (which can alternatively be called software instances, virtual appliances, network functions, virtual nodes, virtual network functions, containers, pods, etc.) can be hosted and/or run by environment 1000. Such applications can implement various features, functions, procedures, etc. of various embodiments disclosed herein.

In some embodiments, each application 1040 can be arranged in a pod, which can include one or more containers 1041, such as 1041a-b shown for a particular application 1040 in FIG. 10. Container 1041a-b can encapsulate respective services 1042a-b of the particular application 1040. For example, a “pod” (e.g., a Kubernetes pod) can be a basic execution unit of an application, i.e., the smallest and simplest unit that can be created and deployed in environment 1000. Each pod can include a plurality of resources shared by containers within the pod (e.g., resources 1043 shared by containers 1041a-b). For example, a pod can represent processes running on a cluster and can encapsulates an application's containers (including services therein), storage resources, a unique network IP address, and options that govern how the container(s) should run. In general, containers can be relatively decoupled from underlying physical or virtual computing infrastructure.

In addition to the applications 1040, a traffic controller 1045 can also be run in the virtualization environment 1000 shown in FIG. 10. Traffic controller 1045 can include an ingress controller that controls external traffic into the application pods (e.g., from application clients, such as wireless devices), and an egress controller that controls traffic from the application pods towards external destinations (e.g., to application clients). For example, ingress traffic can include requests from application client(s) to an application service, and egress traffic can include responses from the application service to the application client(s).

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Embodiments of the techniques and apparatus described herein also include, but are not limited to, the following enumerated examples:

E1. A wireless device configured for use with a vehicle powered by a battery, the wireless device comprising:
radio transceiver circuitry configured to communicate with a wide-area wireless network and via one or more short-range wireless connections; and
processing circuitry operably coupled to the radio transceiver circuitry, whereby the processing circuitry and the radio transceiver circuitry are configured to:
   receive first status information associated with the battery via a first short-range wireless connection;
   determine location information associated with the vehicle; and
   transmit the location information and the first status information to a management server via the wide-area wireless network.
      E2. The wireless device of embodiment E1, wherein the first status information includes one or more of the following: current state of charge (SOC), current state of health (SOH), over temperature (OT) indicator, and one or more error code (EC) counters.
      E3. The wireless device of any of embodiments E1-E2, wherein the processing circuitry and the radio transceiver circuitry are further configured to:
receive first control information for the battery from the management server via the wide-area wireless network; and
transmit the first control information via the first short-range wireless connection.
   E4. The wireless device of embodiment E3, wherein the first control information is based on the location information and the first status information.
   E5. The wireless device of any of embodiments E3-E4, wherein the first control information includes one or more of the following: a command to limit a discharge rate of the battery; a command to stop discharge of the battery; and a service notification for the battery.
   E6. The wireless device of embodiment E5, wherein the command to limit the discharge rate is based on one or more of the following:
a maximum allowed speed at a current vehicle location,
an indication of high vehicle and/or pedestrian traffic at the current vehicle location, and
a current state of charge (SOC) of the battery.
   E7. The wireless device of embodiment E5, wherein the command to stop discharge of the battery is based on one or more of the following:
danger or hazard associated with the current vehicle location,
an indication that the vehicle has been stolen, and
a current state of health (SOH) of the battery,
over temperature (OT) indicator, and
one or more error code (EC) counters exceeding respective thresholds.
   E8. The wireless device of any of embodiments E1-E7, wherein the first short-range wireless connection is between the wireless device and a battery management system (BMS) arranged to control the battery.
   E9. The wireless device of embodiment E8, wherein the processing circuitry and the radio transceiver circuitry are further configured to:
receive second status information associated with the vehicle via a second short-range wireless connection with the vehicle; and
transmit the second status information to the management server via the wide-area wireless network.
   E10. The wireless device of any of embodiments E8-E9, wherein the processing circuitry and the radio transceiver circuitry are further configured to:
receive second control information for the vehicle from the management server via the wide-area wireless network; and
transmit the second control information via the second short-range wireless connection.
   E11. The wireless device of any of embodiments E1-E7, wherein the first short-range wireless connection is between the wireless device and the vehicle.
   E12. The wireless device of embodiment E11, wherein the processing circuitry and the radio transceiver circuitry are further configured to:
receive second status information associated with the vehicle via the first short-range wireless connection; and
transmit the second status information to the management server via the wide-area wireless network.
   E13. The wireless device of any of embodiments E11-E12, wherein the processing circuitry and the radio transceiver circuitry are further configured to:
receive second control information for the vehicle from the management server via the wide-area wireless network; and
transmit the second control information via the first short-range wireless connection.
   E14. The wireless device of embodiment E9 or E12, wherein the second status information includes one or more of the following: total usage for the vehicle, usage since the most recent service to the vehicle, total cycles of the battery, vehicle error codes, and vehicle accelerometer records.
   E14a. The wireless device of embodiment E10 or E13, wherein the second control information includes one or more of the following: a service notification and an alarm notification.
   E15. The wireless device of any of embodiments E1-E14a, wherein the location information includes one or more of the following: current location, one or more past locations, current speed, one or more past speeds, current heading, current route, and starting point and destination for a current route.
   E16. The wireless device of any of embodiments E1-E15, wherein:
the location information includes a current route; and
the processing circuitry is further configured to receive, from the management server, information associated with one or more locations along the current route.
   E17. The wireless device of embodiment E16, wherein the information associated with the one or more locations include any of the following:
identifiers of businesses located at the one or more locations; and
information about services offered at the one or more locations.
   E18. The wireless device of any of embodiments E1-E17, further comprising a display operably coupled to the processing circuitry, wherein the processing circuitry is further configured to display at least a portion of the following on the display:
first status information associated with the battery; and
second status information associated with the vehicle.
   E19. The wireless device of any of embodiments E1-E18, wherein the vehicle is one of the following: a car, a truck, a scooter, or a motorcycle.
   E20. A method for a wireless device configured for use with a vehicle powered by a battery, the method comprising:
receiving first status information associated with the battery via a first short-range wireless connection;
determining location information associated with the vehicle; and
transmitting the location information and the first status information to a management server via the wide-area wireless network.
   E21. The method of embodiment E20, wherein the first status information includes one or more of the following: current state of charge (SOC), current state of health (SOH), over temperature (OT) indicator, and one or more error code (EC) counters.
   E22. The method of any of embodiments E20-E21, further comprising:
receiving first control information for the battery from the management server via the wide-area wireless network; and
transmitting the first control information via the first short-range wireless connection.
   E23. The method of embodiment E22, wherein the first control information is based on the location information and the first status information.
   E24. The method of any of embodiments E22-E23, wherein the first control information includes one or more of the following:
a command to limit a discharge rate of the battery;
a command to stop discharge of the battery; or
a service notification for the battery.
   E25. The method of embodiment E24, wherein the command to limit the discharge rate is based on one or more of the following:
a maximum allowed speed at a current vehicle location,
an indication of high vehicle and/or pedestrian traffic at the current vehicle location, and
a current state of charge (SOC) of the battery.
   E26. The method of embodiment E24, wherein the command to stop discharge of the battery is based on one or more of the following:
danger or hazard associated with the current vehicle location,
an indication that the vehicle has been stolen, and
a current state of health (SOH) of the battery,
over temperature (OT) indicator, and
one or more error code (EC) counters exceeding respective thresholds.
   E27. The method of any of embodiments E20-E26, wherein the first short-range wireless connection is between the wireless device and a battery management system (BMS) arranged to control the battery.
   E28. The method of embodiment E27, further comprising:
receiving second status information associated with the vehicle via a second short-range wireless connection with the vehicle; and
transmitting the second status information to the management server via the wide-area wireless network.
   E29. The method of any of embodiments E27-E28, further comprising:
receiving second control information for the vehicle from the management server via the wide-area wireless network; and
transmitting the second control information via the second short-range wireless connection.
   E30. The method of any of embodiments E20-E26, wherein the first short-range wireless connection is between the wireless device and the vehicle.
   E31. The method of embodiment E30, further comprising:
receiving second status information associated with the vehicle via the first short-range wireless connection; and
transmitting the second status information to the management server via the wide-area wireless network.
   E32. The method of any of embodiments E30-E31, further comprising:
receiving second control information for the vehicle from the management server via the wide-area wireless network; and
transmitting the second control information via the first short-range wireless connection.
   E33. The method of embodiment E28 or E31, wherein the second status information includes one or more of the following: total usage for the vehicle, usage since the most recent service to the vehicle, total cycles of the battery, vehicle error codes, and vehicle accelerometer records.
   E33a. The method of embodiment E29 or E32, wherein the second control information includes one or more of the following: a service notification and an alarm notification.
   E34. The method of any of embodiments E20-E33a, wherein the location information includes one or more of the following: current location, one or more past locations, current speed, one or more past speeds, current heading, current route, and starting point and destination for a current route.
   E35. The method of any of embodiments E20-E34, wherein:
the location information includes a current route; and
the method further comprises receiving, from the management server, information associated with one or more locations along the current route.
   E36. The method of embodiment E35, wherein the information associated with the one or more locations include any of the following:
identifiers of businesses located at the one or more locations; and
information about services offered at the one or more locations.
   E37. The method of any of embodiments E20-E36, further comprising displaying at least a portion of the following on a display associated with the wireless device:
first status information associated with the battery; and
second status information associated with the vehicle.
   E38. The method of any of embodiments E20-E37, wherein the vehicle is one of the following: a car, a truck, a scooter, or a motorcycle.
   E39. A wireless device configured for use with a battery-powered vehicle, the wireless device being further arranged to perform operations corresponding to any of the methods of embodiments E20-E38.
   E40. A non-transitory, computer-readable medium storing computer-executable instructions that, when executed by processing circuitry, configure a wireless device to perform operations corresponding to any of embodiments E20-E38.
   E41. A computer program product comprising computer-executable instructions that, when executed by processing circuitry, configure a wireless device to perform operations corresponding to any of embodiments E20-E38.
   E42. A management server for one or more vehicles powered by batteries, the management server comprising:
interface circuitry configured to communicate with wireless devices associated with the respective vehicles via a wide-area wireless network; and
processing circuitry operably coupled to the interface circuitry, whereby the processing circuitry and the interface circuitry are configured to:
   receive, from one of the wireless devices, location information for an associated vehicle and first status information for the associated vehicle's battery;
   determine first control information for the battery based on the location information and the first status information; and
   transmit the first control information to the wireless device via the wide-area wireless network.
      E43. The management server of embodiment E42, wherein the first status information includes one or more of the following: current state of charge (SOC), current state of health (SOH), over temperature (OT) indicator, and one or more error code (EC) counters.
      E44. The management server of any of embodiments E42-E43, wherein the location information includes one or more of the following: current location, one or more past locations, current speed, one or more past speeds, current heading, current route, and starting point and destination for the current route.
      E45. The management server of any of embodiments E42-E44, wherein:
the processing circuitry is configured to determine the first control information by determining a maximum discharge rate of the battery based on one or more of the following:
   a maximum allowed speed at a current vehicle location,
   an indication of high vehicle and/or pedestrian traffic at the current vehicle location, and
   a current state of charge (SOC) of the battery.
the first control information is a command to limit a discharge rate of the battery according to the determined maximum discharge rate.
   E46. The management server of any of embodiments E42-E44, wherein:
the processing circuitry is configured to determine the first control information by detecting one or more of the following:
   a danger or hazard associated with the current vehicle location,
   an indication that the vehicle has been stolen, and
   that the current state of health (SOH) of the battery is below a minimum operational threshold,
   that one or more error code (EC) counters have exceeded respective thresholds, and
   an over temperature (OT) indication; and
the first control information is a command to stop discharge of the battery.
   E47. The management server of any of embodiments E42-E44, wherein the processing circuitry is configured to determine the first control information by determining a service notification for the battery based on a current state of health (SOH) of the battery.
   E48. The management server of any of embodiments E42-E47, wherein the processing circuitry and the interface circuitry are further configured to:
receive, from the wireless device, second status information for the associated vehicle;
determine second control information for the vehicle based on the location information and the second status information; and
transmit the second control information to the wireless device via the wide-area wireless network.
   E49. The management server of embodiment E48, wherein one or more of the following applies:
the first control information is also determined based on the second status information; and
the second control information is also determined based on the first status information.
   E50. The management server of any of embodiments E48-E49, wherein the second status information includes one or more of the following: total usage for the vehicle, usage since the most recent service to the vehicle, total cycles of the battery, vehicle error codes, and vehicle accelerometer records.
   E51. The management server of any of embodiments E48-E50, wherein the second control information includes one or more of the following: a service notification and an alarm notification.
   E52. The management server of any of embodiments E42-E51, wherein:
the one or more vehicles comprises a fleet of vehicles; and
the processing circuitry and the interface circuitry are further configured to:
   receive, from the wireless devices associated with the respective fleet vehicles, respective location information for the vehicles and respective first status information for the vehicle batteries;
   determine a preferred geographic distribution of the vehicles of the fleet based on the respective location information and the respective first status information.
      E53. The management server of embodiment E52, wherein the processing circuitry is configured to determine the preferred geographic distribution by:
based on the location information, determining that a first number of vehicles are in a first geographic area;
based on the first status information, determining a state of charge (SOC) statistic for the vehicles in the first geographic area; and
determining that the first number should be increased when the SOC statistic is below a first threshold.
   E54. The management server of embodiment E53, wherein the processing circuitry is further configured to determine the preferred geographic distribution by determining that the first number should be decreased when the SOC statistic is above a second threshold.
   E55. The management server of any of embodiments E53-E54, wherein the SOC statistic is one of the following: mean, median, minimum, or maximum.
   E56. The management server of any of embodiments E42-E51, wherein:
the location information includes a current route; and
the processing circuitry and the interface circuitry are further configured to: determine one or more locations along the current route; and
   send, to the wireless device, information associated with the determined locations.
      E57. The management server of embodiment E56, wherein the information associated with the determined locations include any of the following:
identifiers of businesses located at the determined locations; and
information about services offered at the determined locations.
   E58. The management server of any of embodiments E42-E57, wherein the one or more vehicles are any of the following: cars, trucks, scooters, or motorcycles.
   E59. A method for managing one or more vehicles powered by batteries, the method comprising:
receiving, from a wireless device via a wide-area wireless network, location information for the vehicle associated with the wireless device and first status information for the associated vehicle's battery;
determining first control information for the battery based on the location information and the first status information; and
transmitting the first control information to the wireless device via the wide-area wireless network.
   E60. The method of embodiment E59, wherein the first status information includes one or more of the following: current state of charge (SOC), current state of health (SOH), over temperature (OT) indicator, and one or more error code (EC) counters.
   E61. The method of any of embodiments E59-E60, wherein the location information includes one or more of the following: current location, one or more past locations, current speed, one or more past speeds, current heading, current route, and starting point and destination for the current route.
   E62. The method of any of embodiments E59-E61, wherein:
determining the first control information comprises determining a maximum discharge rate of the battery based on one or more of the following:
   a maximum allowed speed at a current vehicle location,
   an indication of high vehicle and/or pedestrian traffic at the current vehicle location, and
   a current state of charge (SOC) of the battery; and
the first control information is a command to limit a discharge rate of the battery according to the determined maximum discharge rate.
   E63. The method of any of embodiments E59-E61, wherein:
determining the first control information comprises detecting one or more of the following:
   a danger or hazard associated with the current vehicle location,
   an indication that the vehicle has been stolen, and
   that the current state of health (SOH) of the battery is below a minimum operational threshold,
   that one or more error code (EC) counters have exceeded respective thresholds, and
   an over temperature (OT) indication; and
the first control information is a command to stop discharge of the battery.
   E64. The method of any of embodiments E59-E61, wherein determining the first control information comprises determining a service notification for the battery based on a current state of health (SOH) of the battery.
   E65. The method of any of embodiments E59-E64, further comprising:
receiving, from the wireless device, second status information for the associated vehicle;
determining second control information for the vehicle based on the location information and the second status information; and
transmitting the second control information to the wireless device via the wide-area wireless network.
   E66. The method of embodiment E65, wherein one or more of the following applies:
the first control information is also determined based on the second status information; and
the second control information is also determined based on the first status information.
   E67. The method of any of embodiments E65-E66, wherein the second status information includes one or more of the following: total usage for the vehicle, usage since the most recent service to the vehicle, total cycles of the battery, vehicle error codes, and vehicle accelerometer records.
   E68. The method of any of embodiments E65-E67, wherein the second control information includes one or more of the following: a service notification and an alarm notification.
   E69. The method of any of embodiments E59-E68, wherein:
the one or more vehicles comprises a fleet of vehicles; and
the method further comprises:
   receiving, from the wireless devices associated with the respective fleet vehicles, respective location information for the vehicles and respective first status information for the vehicle batteries;
   determining a preferred geographic distribution of the vehicles of the fleet based on the respective location information and the respective first status information.
      E70. The method of embodiment E69, wherein determining the preferred geographic distribution comprises:
based on the location information, determining that a first number of vehicles are in a first geographic area;
based on the first status information, determining a state of charge (SOC) statistic for the vehicles in the first geographic area; and
determining that the first number should be increased when the SOC statistic is below a first threshold.
   E71. The method of embodiment E70, wherein determining the preferred geographic distribution further comprises determining that the first number should be decreased when the SOC statistic is above a second threshold.
   E72. The method of any of embodiments E70-E71, wherein the SOC statistic is one of the following: mean, median, minimum, or maximum.
   E73. The method of any of embodiments E59-E68, wherein:
the location information includes a current route; and
the method further comprises:
   determining one or more locations along the current route; and
   sending, to the wireless device, information associated with the determined locations.
      E74. The method of embodiment E73, wherein the information associated with the determined locations include any of the following:
identifiers of businesses located at the determined locations; and
information about services offered at the determined locations.
   E75. The method of any of embodiments E59-E74, wherein the one or more vehicles are any of the following: cars, trucks, scooters, or motorcycles.
   E76. A management server for one or more vehicles powered by batteries, the management server being arranged to perform operations corresponding to any of the methods of embodiments E59-E75.
   E77. A non-transitory, computer-readable medium storing computer-executable instructions that, when executed by processing circuitry, configure a management server to perform operations corresponding to any of embodiments E59-E75.
   E78. A computer program product comprising computer-executable instructions that, when executed by processing circuitry, configure a management server to perform operations corresponding to any of embodiments E59-E75.

1. A method for a wireless device configured for use with a vehicle powered by a battery, the method comprising:
receiving first status information associated with the battery via a first short-range wireless connection;
determining location information associated with the vehicle; and
transmitting the location information and the first status information to a management server via the wide-area wireless network.

2. The method of claim 1, wherein the first status information includes one or more of the following: current state of charge (SOC), current state of health (SOH), over temperature (OT) indicator, and one or more error code (EC) counters.

3. The method of claim 1, further comprising:
receiving first control information for the battery from the management server via the wide-area wireless network; and
transmitting the first control information via the first short-range wireless connection.

4. The method of claim 3, wherein the first control information is based on the location information and the first status information.

5. The method of claim 3, wherein the first control information includes one or more of the following:
a command to limit a discharge rate of the battery;
a command to stop discharge of the battery; or
a service notification for the battery.

6. The method of claim 5, wherein the command to limit the discharge rate is based on one or more of the following:
a maximum allowed speed at a current vehicle location,
an indication of high vehicle and/or pedestrian traffic at the current vehicle location, and
a current state of charge (SOC) of the battery.

7. The method of claim 5, wherein the command to stop discharge of the battery is based on one or more of the following:
danger or hazard associated with the current vehicle location,
an indication that the vehicle has been stolen,
a current state of health (SOH) of the battery,
over temperature (OT) indicator, and
one or more error code (EC) counters exceeding respective thresholds.

8. The method of claim 1, further comprising:
transmitting second status information associated with the vehicle to the management server via the wide-area wireless network; and
receiving second control information for the vehicle from the management server via the wide-area wireless network.

9. The method of claim 8, wherein:
the second status information includes one or more of the following: total usage for the vehicle, usage since the most recent service to the vehicle, total cycles of the battery, vehicle error codes, and vehicle accelerometer records; and
the second control information includes one or more of the following: a service notification and an alarm notification.

10. The method of claim 8, wherein:
the first short-range wireless connection is between the wireless device and a battery management system (BMS) arranged to control the battery; and
the method further comprises:
receiving the second status information via a second short-range wireless connection with the vehicle; and
transmitting the second control information via the second short-range wireless connection.

11. The method of claim 8, wherein:
the first short-range wireless connection is between the wireless device and the vehicle; and
the method further comprises:
receiving the second status information via the first short-range wireless connection; and
transmitting the second control information via the first short-range wireless connection.

12. The method of claim 1, wherein the location information includes one or more of the following: current location, one or more past locations, current speed, one or more past speeds, current heading, current route, and starting point and destination for a current route.

13. The method of claim 1, wherein:
the location information includes a current route; and
the method further comprises receiving one or more of the following from the management server:
identifiers of businesses located at one or more locations along the current route; and
information about services offered at the one or more locations.

14. A wireless device configured for use with a vehicle powered by a battery, the wireless device comprising:
radio transceiver circuitry configured to communicate with a wide-area wireless network and via one or more short-range wireless connections; and
processing circuitry operably coupled to the radio transceiver circuitry, whereby the processing circuitry and the radio transceiver circuitry are configured to perform operations corresponding to the method of claim 1.

15. A non-transitory, computer-readable medium storing computer-executable instructions that, when executed by processing circuitry, configure a wireless device to perform operations corresponding to the method of claim 1.

16. A method for a management server to manage one or more vehicles powered by batteries, the method comprising:
receiving, from a wireless device via a wide-area wireless network, location information for a vehicle associated with the wireless device and first status information for the associated vehicle's battery;
determining first control information for the battery based on the location information and the first status information; and
transmitting the first control information to the wireless device via the wide-area wireless network.

17. The method of claim 16, wherein the first status information includes one or more of the following: current state of charge (SOC), current state of health (SOH), over temperature (OT) indicator, and one or more error code (EC) counters;

18. The method of claim 16, wherein the location information includes one or more of the following: current location, one or more past locations, current speed, one or more past speeds, current heading, current route, and starting point and destination for the current route.

19. The method of claim 16, wherein:
determining the first control information comprises determining a maximum discharge rate of the battery based on one or more of the following:
a maximum allowed speed at a current vehicle location,
an indication of high vehicle and/or pedestrian traffic at the current vehicle location, and
a current state of charge (SOC) of the battery; and
the first control information includes a command to limit a discharge rate of the battery according to the determined maximum discharge rate.

20. The method of claim 16, wherein:
determining the first control information comprises detecting one or more of the following:
a danger or hazard associated with the current vehicle location,
an indication that the vehicle has been stolen,
that the current state of health (SOH) of the battery is below a minimum operational threshold,
that one or more error code (EC) counters have exceeded respective thresholds, and
an over temperature (OT) indication; and
the first control information includes a command to stop discharge of the battery.

21. The method of claim 16, wherein determining the first control information comprises determining a service notification for the battery based on a current state of health (SOH) of the battery.

22. The method of claim 16, further comprising:
receiving, from the wireless device, second status information for the associated vehicle;
determining second control information for the vehicle based on the location information and the second status information; and
transmitting the second control information to the wireless device via the wide-area wireless network.

23. The method of claim 22, wherein:
the second status information includes one or more of the following: total usage for the vehicle, usage since the most recent service to the vehicle, total cycles of the battery, vehicle error codes, and vehicle accelerometer records; and
the second control information includes one or more of the following: a service notification and an alarm notification.

24. The method of claim 22, wherein one or more of the following applies:
the first control information is also determined based on the second status information; and
the second control information is also determined based on the first status information.

25. The method of claim 16, wherein:
the one or more vehicles comprises a fleet of vehicles; and
the method further comprises:
receiving, from wireless devices associated with the respective vehicles, respective location information for the vehicles and respective first status information for the vehicle batteries;
determining a preferred geographic distribution of the fleet of vehicles based on the respective location information and the respective first status information.

26. The method of claim 25, wherein determining the preferred geographic distribution comprises:
determining that a first number of vehicles are in a first geographic area based on the location information;
determining a state of charge (SOC) statistic for the vehicles in the first geographic area based on the first status information; and
determining that the first number should be increased when the SOC statistic is below a first threshold.

27. The method of claim 26, wherein determining the preferred geographic distribution further comprises determining that the first number should be decreased when the SOC statistic is above a second threshold.

28. The method of claim 26, wherein the SOC statistic is one of the following: mean, median, minimum, or maximum.

29. The method of claim 16, wherein the location information includes a current route and the method further comprises:
determining one or more locations along the current route; and
sending one or more of the following to the wireless device:
identifiers of businesses located at the one or more locations; and
information about services offered at the one or more locations.

30. A management server for one or more vehicles powered by batteries, the management server comprising:
interface circuitry configured to communicate with wireless devices associated with the respective vehicles via a wide-area wireless network; and
processing circuitry operably coupled to the interface circuitry, whereby the processing circuitry and the interface circuitry are configured to perform operations corresponding to the method of claim 16.

31. A non-transitory, computer-readable medium storing computer-executable instructions that, when executed by processing circuitry, configure a management server to perform operations corresponding to the method of claim 16.
